(19) United States
(12) Patent Application Publication
(10) Pub. No.: US 2026/0039047 A1
(43) Pub. Date: Feb. 5, 2026

(54) CONNECTOR AND ELECTRICAL CONNECTION ASSEMBLY

(71) Applicant: Tyco Electronics (Shanghai) Co., Ltd., Shanghai (CN)

(72) Inventors: Pengpeng (Tom) Tang, Shanghai (CN); Xiao (Nichee) Zhou, Shanghai (CN)

(73) Assignee: Tyco Electronics (Shanghai) Co., Ltd., Shanghai (CN)

(21) Appl. No.: 19/285,290

(22) Filed: Jul. 30, 2025

(30) Foreign Application Priority Data
Jul. 30, 2024 (CN) 202411037444.2

(51) Int. Cl. H01R 12/91; H01R 12/70

(52) U.S. Cl. CPC H01R 12/91; H01R 12/707; H01R 2201/26

(57) ABSTRACT

A connector includes a housing having an insertion slot, a top surface and a bottom surface opposite the top surface in a height direction of the housing, and a terminal inserted into the insertion slot of the housing. The terminal has a soldering end exposed from the top surface of the housing and a connecting end exposed from the bottom surface of the housing. The soldering end of the terminal is solderable in a surface mount manner to a first circuit board and the connecting end of the terminal is electrically connectable with a second circuit board. The terminal floats relative to the second circuit board in a transverse direction, a longitudinal direction, and the height direction of the housing.

### CROSS-REFERENCE TO RELATED APPLICATION

This application claims the benefit of the filing date under 35 U.S.C. § 119(a)-(d) of Chinese Patent Application No. 202411037444.2, filed on Jul. 30, 2024.

### FIELD OF THE INVENTION

The present invention relates to a connector and an electrical connection assembly comprising the connector.

### BACKGROUND OF THE INVENTION

At present, required installation space of modules in vehicles is reduced, which improves overall vehicle space utilization. However, the functionality of the modules continues to increase and, to meet the functional requirements of the module, a double-layer circuit board solution has been designed. Considering assembly process errors of the double-layer circuit board, it is necessary to design a floating connector between two layers of circuit boards to absorb these errors.

Conventional inter-board floating connectors on the market include a male connector and a female connector. Such a solution requires two connectors, and the installation of the module requires two surface mount soldering processes, thereby increasing material management costs and manufacturing costs.

### SUMMARY OF THE INVENTION

A connector includes a housing having an insertion slot, a top surface and a bottom surface opposite the top surface in a height direction of the housing, and a terminal inserted into the insertion slot of the housing. The terminal has a soldering end exposed from the top surface of the housing and a connecting end exposed from the bottom surface of the housing. The soldering end of the terminal is solderable in a surface mount manner to a first circuit board and the connecting end of the terminal is electrically connectable with a second circuit board. The terminal floats relative to the second circuit board in a transverse direction, a longitudinal direction, and the height direction of the housing.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a connector according to a first embodiment of the present invention, viewed from the top;

FIG. 2 shows an illustrative exploded view of the connector according to the first embodiment of the present invention;

FIG. 3 shows an illustrative perspective view of the connector according to the first embodiment of the present invention, viewed from the bottom;

FIG. 4 shows an illustrative plan view of the connector according to the first embodiment of the present invention, viewed from the front side, showing a first circuit board and a second circuit board;

FIG. 5 shows an illustrative plan view of the connector according to the first embodiment of the present invention, viewed from the left side, showing the first circuit board and the second circuit board;

FIG. 6 shows an illustrative perspective view of a connector according to a second embodiment of the present invention, viewed from the top;

FIG. 7 shows an illustrative exploded view of the connector according to the second embodiment of the present invention;

FIG. 8 shows a longitudinal sectional view of the connector according to the second embodiment of the present invention; and

FIG. 9 shows a plan sectional view of the connector according to the second embodiment of the present invention, showing a first circuit board and a second circuit board.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

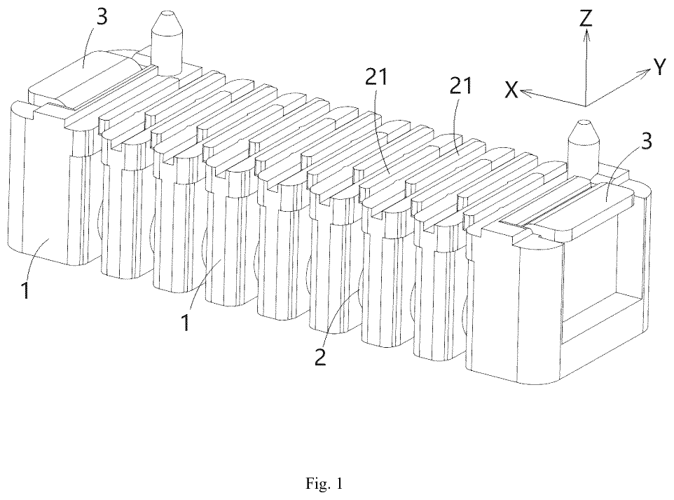

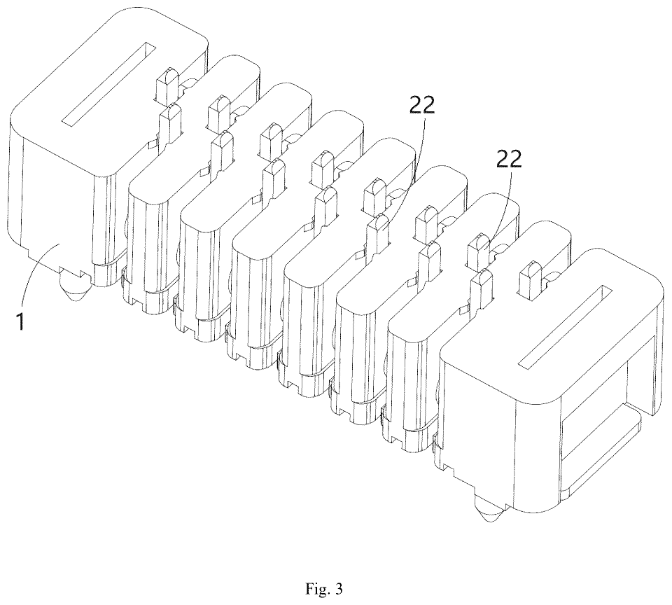

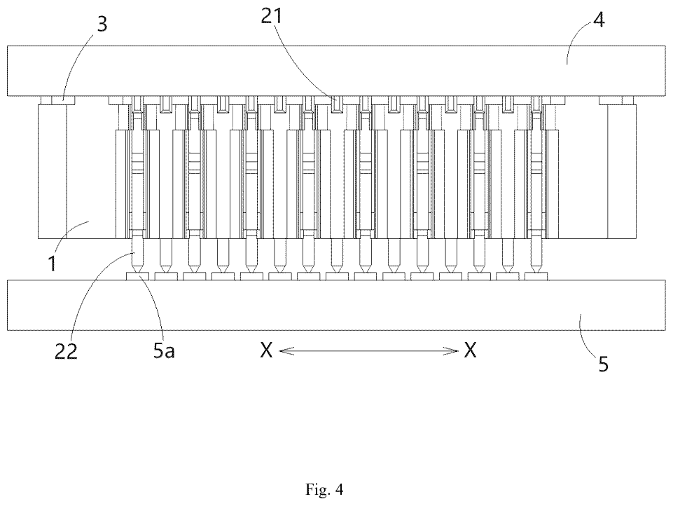

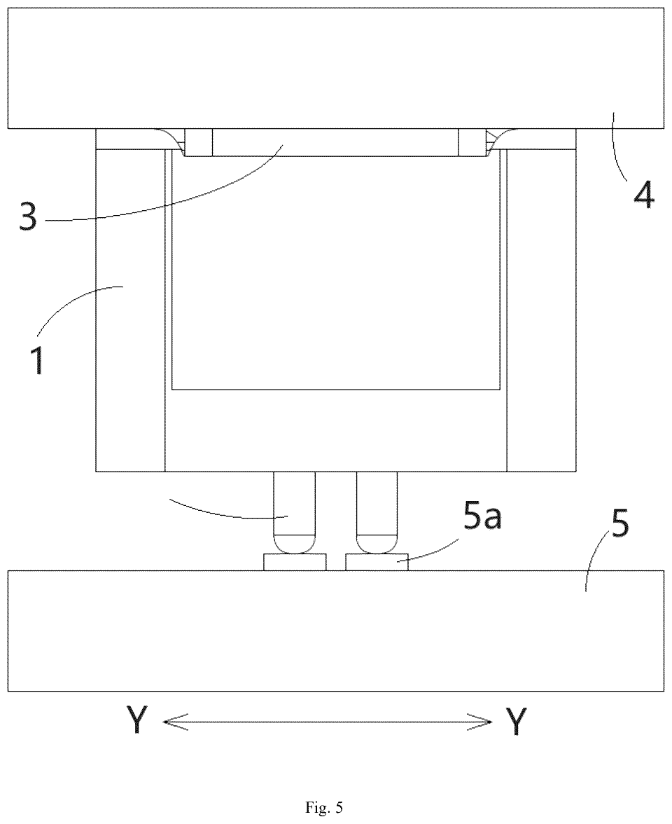

As shown in FIGS. 1 to 5, in an exemplary embodiment of the present invention, a connector is disclosed. The connector includes a housing 1 and a terminal 2. The housing 1 is provided with an insertion slot 10 and having top and bottom surfaces opposite to each other in a height direction Z of the housing. The terminal 2 is inserted into the insertion slot 10 of the housing 1 and has a soldering end 21 exposed from the top surface of the housing 1 and a connecting end 22 exposed from the bottom surface of the housing 1. The soldering end 21 of the terminal 2 is adapted to be soldered in a surface mount manner to a first circuit board 4, and the connecting end 22 of the terminal 2 is configured for electrical connection with a second circuit board 5. The terminal 2 of the connector is capable of floating relative to the second circuit board 5 in a transverse direction X, a longitudinal direction Y and the height direction Z of the housing 1.

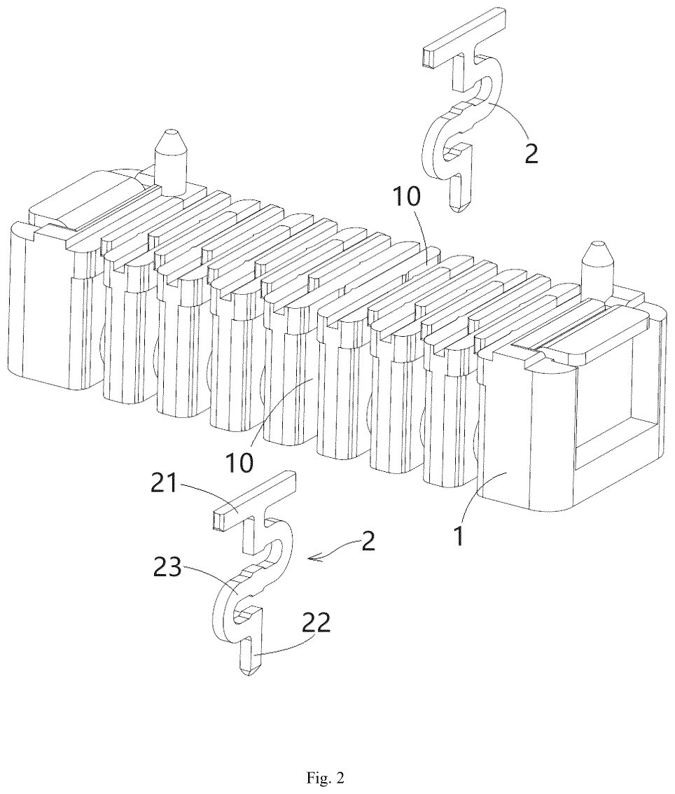

As shown in FIGS. 2 to 5, in the illustrated embodiment, the connecting end 22 of the terminal 2 is configured for electrical contact with a contact pad 5a on the second circuit board 5. A dimension of the connecting end 22 of the terminal 2 in the transverse direction X of the housing 1 is smaller than a dimension of the second circuit board 5 in the transverse direction X of the housing 1, to allow the terminal 2 of the connector to float relative to the second circuit board 5 in the transverse direction X.

In the illustrated embodiment, a dimension of the connecting end 22 of the terminal 2 in the longitudinal direction Y of the housing 1 is smaller than a dimension of the second circuit board 5 in the longitudinal direction Y of the housing 1, to allow the terminal 2 of the connector to float relative to the second circuit board 5 in the longitudinal direction Y.

As shown in FIG. 2, in the illustrated embodiment, the terminal 2 further has an elastic portion 23 located between the soldering end 21 and the connecting end 22 of the terminal 2, the elastic portion 23 being elastically deformable in the height direction Z of the housing 1, to allow the terminal 2 of the connector to float relative to the second circuit board 5 in the height direction Z. In the illustrated embodiment, the elastic portion 23 is S-shaped, and has an upper end and a lower end connected to the soldering end 21 and the connecting end 22, respectively. In the illustrated embodiment, due to the S-shape of the elastic section 23 of terminal 2 and its relatively thin thickness, the elastic section 23 of terminal 2 is enabled to deform elastically not only in the height direction Z, but also in the transverse direction X and longitudinal direction Y.

As shown in FIG. 2, in the illustrated embodiment, the soldering end 21 is in the form of a strip extending in the longitudinal direction Y of the housing 1, and the connecting end 22 is in the form of a post extending in the height direction Z of the housing 1. The upper end of the elastic portion 23 is connected to a middle portion of the soldering end 21, and the connecting end 22 extends downwardly from the lower end of the elastic portion 23 in the height direction Z.

In the illustrated embodiment, the housing 1 has front and rear sides opposite to each other in the longitudinal direction Y thereof, a row of insertion slots 10 are formed on each of the front side and the rear side of the housing 1, and the row of insertion slots 10 on the front side and the row of insertion slots 10 on the rear side are arranged alternately in the transverse direction X of the housing 1. The connector comprises two rows of the terminals 2, the two rows of terminals 2 are respectively inserted into the row of insertion slots 10 on the front side and the row of insertion slots 10 on the rear side of the housing 1.

In the illustrated embodiment, the housing 1 has left and right sides opposite to each other in the transverse direction X thereof, a soldering pin 3 is fixed on each of the left and right sides of the housing 1, as shown in FIG. 1, and the soldering pins 3 and the two rows of terminals 2 are adapted to be soldered simultaneously to the first circuit board 4 in a surface mount manner.

In another exemplary embodiment of the present invention, an electrical connection assembly is disclosed. The electrical connection assembly includes a first circuit board 4, a second circuit board 5 and the afore-mentioned connector. The second circuit board 5 is provided with a contact pad 5a. The soldering end 21 of the terminal 2 of the connector is soldered to the first circuit board 4, and the connecting end 22 of the terminal 2 is in electrical contact with the contact pad 5a on the second circuit board 5.

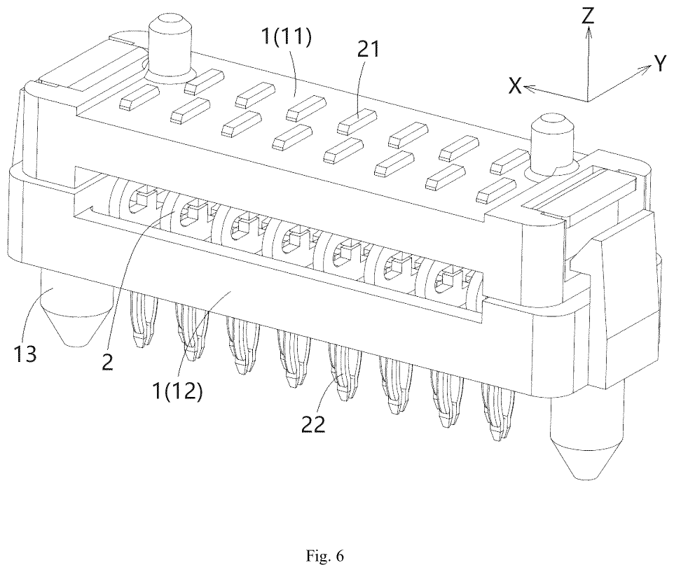

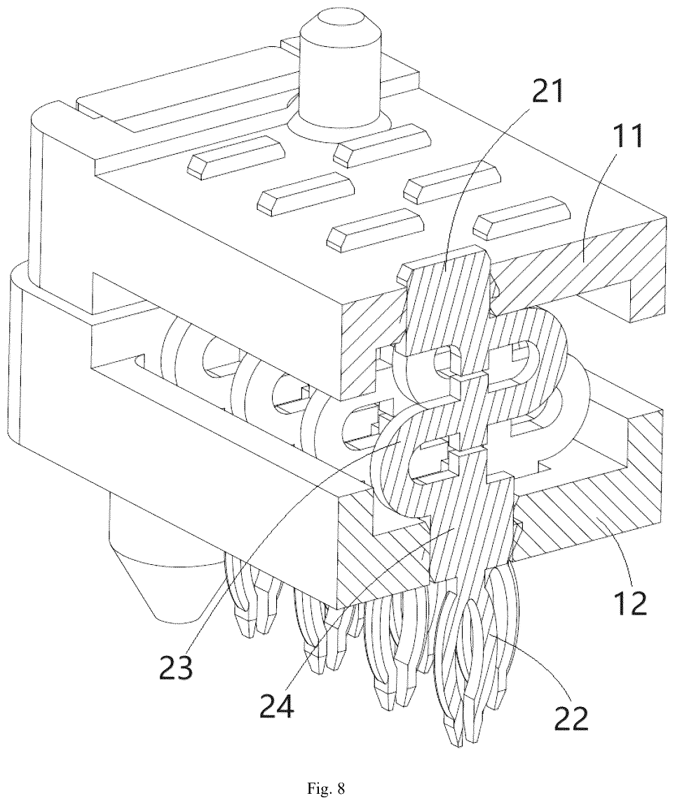

FIGS. 6-9 illustrates the second embodiment.

As shown in FIGS. 6 to 9, in an exemplary embodiment of the present invention, a connector is disclosed. The connector includes a housing 1 and a terminal 2. The housing 1 is provided with an insertion slot 10 and having top and bottom surfaces opposite to each other in a height direction Z of the housing. The terminal 2 is inserted into the insertion slot 10 of the housing 1 and having a soldering end 21 exposed from the top surface of the housing 1 and a connecting end 22 exposed from the bottom surface of the housing 1. The soldering end 21 of the terminal 2 is adapted to be soldered in a surface mount manner to a first circuit board 4, and the connecting end 22 of the terminal 2 is configured for electrical connection with a second circuit board 5. The terminal 2 of the connector is capable of floating relative to the second circuit board 5 in a transverse direction X, a longitudinal direction Y and the height direction Z of the housing 1.

As shown in FIGS. 6 to 9, in the illustrated embodiment, the housing 1 includes a fixing shell 11 and a floating shell 12. The fixing shell 11 is configured to be fixed to the first circuit board 4. The floating shell 12 is located below the fixing shell 11 and capable of floating relative to the fixing shell 11. The soldering end 21 of the terminal 2 is fixed to the fixing shell 11, and the connecting end 22 of the terminal 2 protrudes from the bottom of the floating shell 12 and is configured to be press-fitted into an insertion hole 5b of the second circuit board 5. The terminal 2 further has a fixing portion 24 fixed into the floating shell 12 and an elastic portion 23 located between the soldering end 21 and the fixing portion 24, such that the terminal 2 can float with the floating shell 12 relative to the second circuit board 5.

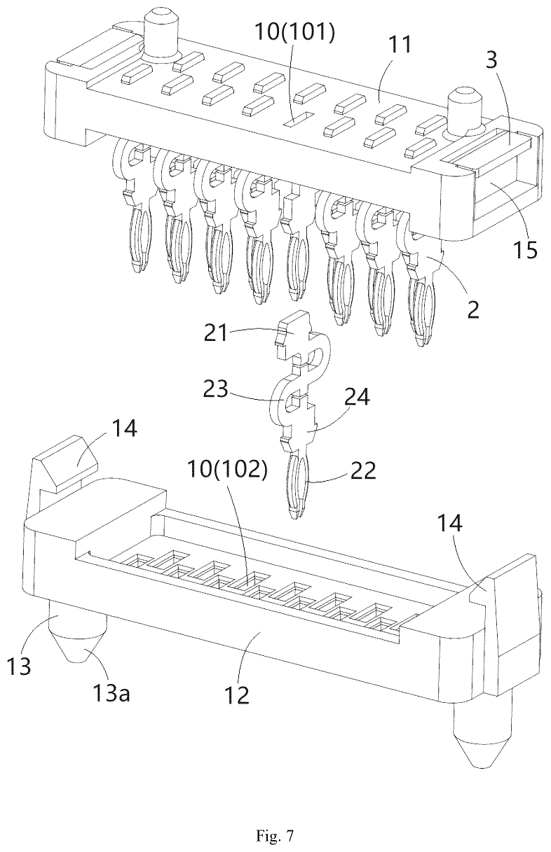

As shown in FIGS. 6 and 7, in the illustrated embodiment, a positioning post 13 is formed on the bottom of the floating shell 12. The positioning post 13 is configured to cooperate with a positioning hole of the second circuit board 5 to guide the press-fitting of the connecting end 22 of the terminal 2 into the insertion hole 5b of the second circuit board 5. In the illustrated embodiment, the positioning post 13 has a tapered guide end 13a. The tapered guide end 13a is configured to guide the insertion of the positioning post 13 into the positioning hole of the second circuit board 5.

In the illustrated embodiment, as shown in FIG. 7, the elastic portion 23 is S-shaped, and has an upper end and a lower end connected to the soldering end 21 and the fixing portion 24, respectively, and the connecting end 22 extends downwardly from the fixing portion 24 in the height direction Z of the housing 1. In the illustrated embodiment, due to the S-shape of the elastic section 23 of terminal 2 and its relatively thin thickness, the elastic section 23 of terminal 2 is enabled to deform elastically not only in the height direction Z, but also in the transverse direction X and longitudinal direction Y.

As shown in FIG. 7, in the illustrated embodiment, the insertion slot 10 includes an upper insertion slot 101 located in the fixing shell 11, and the soldering end 21 of the terminal 2 is in the shape of a flat plate and is inserted into the upper insertion slot 101 of the fixing shell 11 in an interference fit. The insertion slot 10 further includes a lower insertion slot 102 located in the floating shell 12, and the fixing portion 24 of the terminal 2 is in the shape of a flat plate and is inserted into the lower insertion slot 102 of the floating shell 12 in an interference fit.

As shown in FIGS. 6 to 8, in the illustrated embodiment, two rows of the upper insertion slots 101 are formed in the fixing shell 11, the connector comprises two rows of the terminals 2, and the soldering ends 21 of the two rows of terminals 2 are respectively inserted into the two rows of upper insertion slots 101. Two rows of the lower insertion slots 102 are formed in the floating shell 12, and the fixing portions 24 of the two rows of terminals 2 are respectively inserted into the two rows of lower insertion slots 102.

As shown in FIGS. 6 and 7, in the illustrated embodiment, the fixing shell 11 has left and right sides opposite to each other in the transverse direction X, a soldering pin 3 is fixed on each of the left and right sides of the fixing shell 11, and the soldering pins 3 and the two rows of terminals 2 are adapted to be soldered simultaneously to the first circuit board 4 in a surface mount manner.

As shown in FIGS. 6 to 9, in the illustrated embodiment, the floating shell 12 is movably assembled to the fixing shell 11 such that the floating shell 12 can be moved relative to the fixing shell 11 in the transverse direction X, the longitudinal direction Y and the height direction Z of the housing 1, to allow the terminal 2 to float relative to the second circuit board 5 in the transverse direction X, the longitudinal direction Y and the height direction Z.

As shown in FIG. 7, in the illustrated embodiment, an elastic latch 14 is formed on each side of the floating shell 12 in the transverse direction X, a retaining groove 15 is formed on each side of the fixing shell 11 in the transverse direction X, and the elastic latches 14 are movably engaged into the retaining grooves 15, such that the floating shell 12 is moveable relative to the fixing shell 11 in the transverse direction X, the longitudinal direction Y and the height direction Z but not separable from the fixing shell 11.

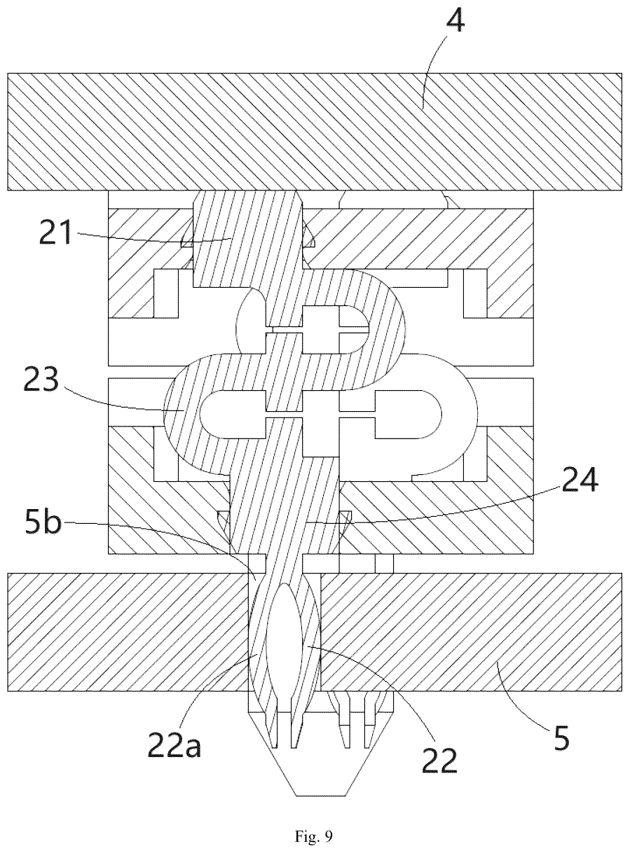

As shown in FIG. 9, in the illustrated embodiment, the connecting end 22 of the terminal 2 includes a pair of arc-shaped elastic arms 22a. The pair of arc-shaped elastic arms 22a are connected to the fixing portion 24 at upper ends thereof. The pair of arc-shaped elastic arms 22a are arched in opposite directions such that the connecting end 22 is fish-eye shaped. Lower ends of the pair of arc-shaped elastic arms 22a are separated by a predetermined distance such that the connecting end 22 of the terminal 2 is elastically deformable to allow the connecting end 22 of the terminal 2 to float relative to the second circuit board 5 in the height direction Z.

In another exemplary embodiment of the present invention, an electrical connection assembly is disclosed. The electrical connection assembly includes a first circuit board 4, a second circuit board 5 and the afore-mentioned connector. The second circuit board 5 is provided with an insertion hole 5b. The soldering end 21 of the terminal 2 of the connector is soldered to the first circuit board 4, and the connecting end 22 of the terminal 2 is press-fitted into the insertion hole 5b of the second circuit board 5.

In another exemplary embodiment of the present invention, a connector is disclosed. The connector includes a housing 1 and a terminal 2. The housing 1 has a fixing shell 11 and a floating shell 12 opposite to each other in a height direction Z of the housing. The terminal 2 is inserted into an insertion slot 10 of the housing 1 and has a soldering end 21 exposed from a top surface of the fixing shell 11 and a connecting end 22 exposed from a bottom surface of the floating shell 12. The soldering end 21 of the terminal 2 is adapted to be soldered in a surface mount manner to a first circuit board 4, and the fixing shell 11 is configured to be fixed to the first circuit board 4. The connecting end 22 of the terminal 2 is configured for electrical connection with a second circuit board 5. The terminal 2 of the connector further has an elastic portion 23 located between the soldering end 21 and the connecting end 22 of the terminal, such that the floating shell 12 can float in a transverse direction X and a longitudinal direction Y.

As shown in FIG. 9, in the illustrated embodiment, the connecting end 22 of the terminal 2 includes a pair of arc-shaped elastic arms 22a. The pair of arc-shaped elastic arms 22a are connected to the fixing portion 24 at upper ends thereof. The pair of arc-shaped elastic arms 22a are arched in opposite directions such that the connecting end 22 is fish-eye shaped. Lower ends of the pair of arc-shaped elastic arms 22a are separated by a predetermined distance such that the connecting end 22 of the terminal 2 is elastically deformable to allow the connecting end 22 of the terminal 2 to float relative to the second circuit board 5 in the height direction Z.

In the aforementioned exemplary embodiments according to the present invention, only one connector is provided between two circuit boards, and a terminal of the connector is soldered to one of the circuit boards and can float relative to the other circuit board, so that positional errors of the two circuit boards can be thereby effectively absorbed and manufacturing costs can be reduced.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector, comprising:
a housing including an insertion slot and having a top surface and a bottom surface opposite to each other in a height direction of the housing; and
a terminal inserted into the insertion slot of the housing and having a soldering end exposed from the top surface of the housing and a connecting end exposed from the bottom surface of the housing, the soldering end of the terminal is solderable in a surface mount manner to a first circuit board, and the connecting end of the terminal is electrically connectable with a second circuit board, the terminal floats relative to the second circuit board in a transverse direction, a longitudinal direction and the height direction of the housing.

2. The connector according to claim 1, wherein the connecting end of the terminal electrically contacts a contact pad on the second circuit board, a dimension of the connecting end of the terminal in the transverse direction of the housing is smaller than a dimension of the second circuit board in the transverse direction of the housing.

3. The connector according to claim 2, wherein a dimension of the connecting end of the terminal in the longitudinal direction of the housing is smaller than a dimension of the second circuit board in the longitudinal direction of the housing.

4. The connector according to claim 3, wherein the terminal has an elastic portion located between the soldering end and the connecting end of the terminal, the elastic portion is elastically deformable in the height direction of the housing.

5. The connector according to claim 4, wherein the elastic portion is S-shaped, and has an upper end connected to the soldering end and a lower end connected to the connecting end.

6. The connector according to claim 5, wherein the soldering end is a strip extending in the longitudinal direction of the housing, the connecting end is a post extending in the height direction of the housing, the upper end of the elastic portion is connected to a middle portion of the soldering end, the connecting end extends downwardly from the lower end of the elastic portion in the height direction.

7. The connector according to claim 2, wherein the housing has a front side and a rear side opposite to each other in the longitudinal direction, a row of insertion slots are formed on each of the front side and the rear side of the housing, the row of insertion slots on the front side and the row of insertion slots on the rear side are arranged alternately in the transverse direction of the housing, the connector has a pair of rows of the terminals, the rows of terminals are respectively inserted into the row of insertion slots on the front side and the row of insertion slots on the rear side of the housing.

8. The connector according to claim 7, wherein the housing has a left side and a right side opposite to each other in the transverse direction, a soldering pin is fixed on each of the left side and the right side of the housing, the soldering pins and the rows of terminals are soldered simultaneously to the first circuit board in a surface mount manner.

9. The connector according to claim 1, wherein the housing includes:
a fixing shell fixed to the first circuit board; and
a floating shell located below the fixing shell and floatable relative to the fixing shell, the soldering end of the terminal is fixed to the fixing shell, and the connecting end of the terminal protrudes from a bottom of the floating shell and is press-fit into an insertion hole of the second circuit board, the terminal has a fixing portion fixed into the floating shell and an elastic portion located between the soldering end and the fixing portion, the terminal is floatable with the floating shell relative to the second circuit board.

10. The connector according to claim 9, wherein a positioning post is formed on the bottom of the floating shell, the positioning post cooperates with a positioning hole of the second circuit board to guide the press-fitting of the connecting end of the terminal into the insertion hole of the second circuit board.

11. The connector according to claim 10, wherein the positioning post has a tapered guide end, the tapered guide end guides insertion of the positioning post into the positioning hole of the second circuit board.

12. The connector according to claim 9, wherein the elastic portion is S-shaped, and has an upper end connected to the soldering end and a lower end connected to the fixing portion, the connecting end extends downwardly from the fixing portion in the height direction of the housing.

13. The connector according to claim 9, wherein the insertion slot has an upper insertion slot located in the fixing shell, the soldering end of the terminal is a flat plate and is inserted into the upper insertion slot of the fixing shell in an interference fit, the insertion slot has a lower insertion slot located in the floating shell, the fixing portion of the terminal is a flat plate and is inserted into the lower insertion slot of the floating shell in an interference fit.

14. The connector according to claim 13, wherein the upper insertion slot is one of a pair of rows of upper insertion slots formed in the fixing shell, the terminal is one of a pair of rows of terminals, the soldering ends of the rows of terminals are respectively inserted into the pair of rows of upper insertion slots, the lower insertion slot is one of a pair of rows of lower insertion slots formed in the floating shell, the fixing portions of the two rows of terminals are respectively inserted into the pair of rows of lower insertion slots.

15. The connector according to claim 14, wherein the fixing shell has a left side and a right side opposite to each other in the transverse direction, a soldering pin is fixed on each of the left side and the right side of the fixing shell, the soldering pins and the rows of terminals are soldered simultaneously to the first circuit board in a surface mount manner.

16. The connector according to claim 9, wherein the floating shell is movably assembled to the fixing shell such that the floating shell can be moved relative to the fixing shell in the transverse direction, the longitudinal direction, and the height direction of the housing, to allow the terminal to float relative to the second circuit board in the transverse direction, the longitudinal direction, and the height direction.

17. The connector according to claim 16, wherein an elastic latch is formed on each side of the floating shell in the transverse direction, a retaining groove is formed on each side of the fixing shell in the transverse direction, the elastic latches are movably engaged into the retaining grooves, such that the floating shell is moveable relative to the fixing shell in the transverse direction, the longitudinal direction, and the height direction but is not separable from the fixing shell.

18. The connector according to claim 9, wherein the connecting end of the terminal includes a pair of arc-shaped elastic arms connected to the fixing portion at upper ends of the pair of arc-shaped elastic arms, the pair of arc-shaped elastic arms are arched in opposite directions such that the connecting end is fish-eye shaped, and a pair of lower ends of the pair of arc-shaped elastic arms are separated by a predetermined distance such that the connecting end of the terminal is elastically deformable to allow the connecting end of the terminal to float relative to the second circuit board in the height direction.

19. An electrical connection assembly, comprising:
a first circuit board;
a second circuit board having a contact pad; and
a connector including:
a housing including an insertion slot and having a top surface and a bottom surface opposite to each other in a height direction of the housing; and
a terminal inserted into the insertion slot of the housing and having a soldering end exposed from the top surface of the housing and a connecting end exposed from the bottom surface of the housing, the soldering end of the terminal is soldered in a surface mount manner to the first circuit board, and the connecting end of the terminal is electrically connected with the contact pad of the second circuit board, the terminal floats relative to the second circuit board in a transverse direction, a longitudinal direction and the height direction of the housing.

20. An electrical connection assembly, comprising:
a first circuit board;
a second circuit board provided with an insertion hole; and
a connector including:
a housing including an insertion slot and having a top surface and a bottom surface opposite to each other in a height direction of the housing; and
a terminal inserted into the insertion slot of the housing and having a soldering end exposed from the top surface of the housing and a connecting end exposed from the bottom surface of the housing, the soldering end of the terminal is soldered in a surface mount manner to the first circuit board, and the connecting end of the terminal is electrically connectable with the second circuit board and press-fit with the insertion hole of the second circuit board, the terminal floats relative to the second circuit board in a transverse direction, a longitudinal direction and the height direction of the housing.
